(19) United States
(12) Patent Application Publication
(10) Pub. No.: US 2012/0090480 A1
(43) Pub. Date: Apr. 19, 2012

(54) VEGETABLE CUTTER

(75) Inventors: Michael Caspar, Hudson, OH (US); Milt Sierra, Avon, OH (US); Chris Piccolomini, North Royatton, OH (US); Brian T. Milliff, Cleveland, OH (US); Anthony E. Buehrer, Berea, OH (US); Michael J. Maczuzak, Bratenahl, OH (US); Cherry A. Bochmann, Bay Village, OH (US)

(73) Assignee: Pragotrade, Inc., Strongsville, OH (US)

(21) Appl. No.: 12/905,145

(22) Filed: Oct. 15, 2010

(51) Int. Cl. A23N 7/02; B26D 1/03; A47J 17/00

(52) U.S. Cl. 99/537; 83/857

(57) ABSTRACT

A cutter used to spirally slice a vegetable including a frame; a shaft supported on the frame, the shaft being freely rotatable and movable along an axis; a holder attached at one end of the shaft; a cutting assembly supported opposite the holder having a first annular blade defining a first bore adapted to form a first peel, a cross cutter adapted to break the first peel into a segment, and a second annular blade defining a second bore, wherein the second annular blade is spaced axially outward from the first blade relative to the holder and wherein the second blade has a diameter smaller than a diameter of the first blade and is adapted to cut a second peel from the core left by the first blade.

### TECHNICAL FIELD

In general, the present invention relates to a cutter used to spirally cut a vegetable. More particularly, the present invention relates to a cutter having a first annular blade and a second annular blade axially spaced from each other, where the second annular blade is smaller than the first annular blade to cut a second spiral from the core that passes through the first blade.

### BACKGROUND OF THE INVENTION

Existing vegetable and fruit peeler and cutter combinations include a mounting head that is supported on a rotatable shaft that supports the vegetable or fruit and allows it to be driven toward a cutting blade while simultaneously rotating the shaft to core and pare the vegetable or fruit. Peeling is accomplished by an arm that tangentially engages a fruit or vegetable as it is rotated to remove the peel. Typically, the coring blade is an annular blade that cuts into the vegetable/fruit as it is driven forward. The simultaneous rotation and translation of the vegetable/fruit as it contacts the blade forms a spiral cut. The annular shape of the blade cuts a spiral peel and leaves a central core. The annular shape of the blade also provides a bearing surface as the vegetable and fruit is driven forward through which the core extends. When the coring and peeling operation is complete, the core is removed from the mounting head and discarded.

The coring blade is particularly suited for the peeling and slicing of fruit, such as apples and pears because the central core contains seeds and is otherwise not useful. With vegetables, however, the central core could further be used. In that regard, the present invention improves upon the art by providing a second blade spaced axially outward from the first blade to provide further spiral slicing of the core after the first cutting operation.

Another issue encountered when attempting to use a prior art apple paring machine to form fries is that, as wider sections of the fruit or vegetable are cut, the width of the peel formed may become very wide for purposes of using the peel as a fry. To that end, it is desirable to provide a cutter that will break the peel as it comes off of the first cutter.

### SUMMARY OF THE INVENTION

The present invention relates to a cutter used to spirally slice a vegetable including a frame supporting a shaft such that it is rotatable and movable along its axis, a holder attached to one end of the shaft on which the vegetable is received, a first blade defining a first bore facing the holder and a second blade defining a second bore spaced axially outward from the first blade, wherein the second blade has a diameter smaller than a diameter of the first blade.

The present invention further provides a cutting assembly for spiral cutting a vegetable including a first blade defining a first bore, a second blade defining a second bore, wherein the first and second blades are axially aligned, wherein a diameter of the second blade is smaller than the diameter of the first blade, and wherein the second blade is spaced axially outward of the first blade.

The present invention further provides a cutting assembly for spiral cutting a vegetable including a first blade defining a first bore, a second blade defining a second bore, the first blade being provided on a first upright and the second blade being provided on a second upright, wherein the first and second uprights are axially spaced from each other, and a cross cutter extending between the supports below the first and second blades.

### FIGURE DESCRIPTIONS

FIG. 1 is a perspective view of a vegetable cutter according to the concepts of the present invention;

FIG. 1A is an enlarged end elevational view of a holder shown in FIG. 1;

FIG. 2 is a perspective view of a vegetable cutter according to the concepts of the present invention having an alternative holder;

FIG. 3 is a top plan view of a cutting assembly according to the concepts of the present invention;

FIG. 4 is a front elevational view of the cutting assembly shown in FIG. 3;

FIG. 5 is a right side elevational view of the cutting assembly shown in FIG. 4;

FIG. 6 is a perspective view of the cutting assembly shown in FIG. 4;

FIG. 7 is an enlarged partially fragmented perspective view of a cutter according to the concepts of the present invention depicting initial cutting of the vegetable by a first blade in the cutting assembly;

FIG. 8 is a perspective view similar to FIG. 7 showing further details of the first cutting operation by the first blade;

FIG. 9 is a perspective view similar to FIG. 8 depicting the peel being formed by the first blade in the cutting assembly being cut into a segment by a cross cutter according to the concepts of the present invention;

FIG. 10 is a perspective view similar to FIG. 9 with a portion of the cutting assembly cut away to show further details of the cross cutter according to the concepts of the present invention;

FIG. 11 is a perspective view similar to FIG. 8 where the vegetable has been cut by the first blade in the cutting assembly forming a core that engages the second blade to form a second peel; and

FIG. 12 is a perspective view similar to FIG. 11 showing further details of the second cutting operation forming a second spiral cut in the core produced by the first cutting operation.

### DETAILED DESCRIPTION OF THE INVENTION

A cutter according to the concepts of the present invention, is generally indicated by the number 10 in the accompanying drawings. Cutter 10 is used to spirally cut a vegetable, for example a potato, into spiral peels as described more completely below. Cutter 10 generally includes a frame 12 that may be supported on a base 14 or attached to a countertop or other work surface as is known. Frame 12 includes an upstanding shaft support 16 on which a shaft 20 is supported such that it is free to rotate and move along its axis A. Shaft support 16 may include a bracket 18 that extends parallel to the shaft 20 and has journals 22 in which the shaft 20 is received. Shaft 20 and journals 22 may be provided with mating threads such that rotation of shaft 20 causes the shaft 20 to simultaneously translate along its axis A. As will be appreciated, the forward or rearward movement of shaft 20 may be controlled by rotating the shaft 20 clockwise or counterclockwise. In the example shown, clockwise rotation of shaft 20 causes the shaft to advance relative to bracket 18.

A blade support 24 may be provided at an opposite end of frame 12 axially outward of the shaft support 16. Blade support 24 provides a surface to which the cutting assembly is attached and may simply be an upstanding plate, as shown.

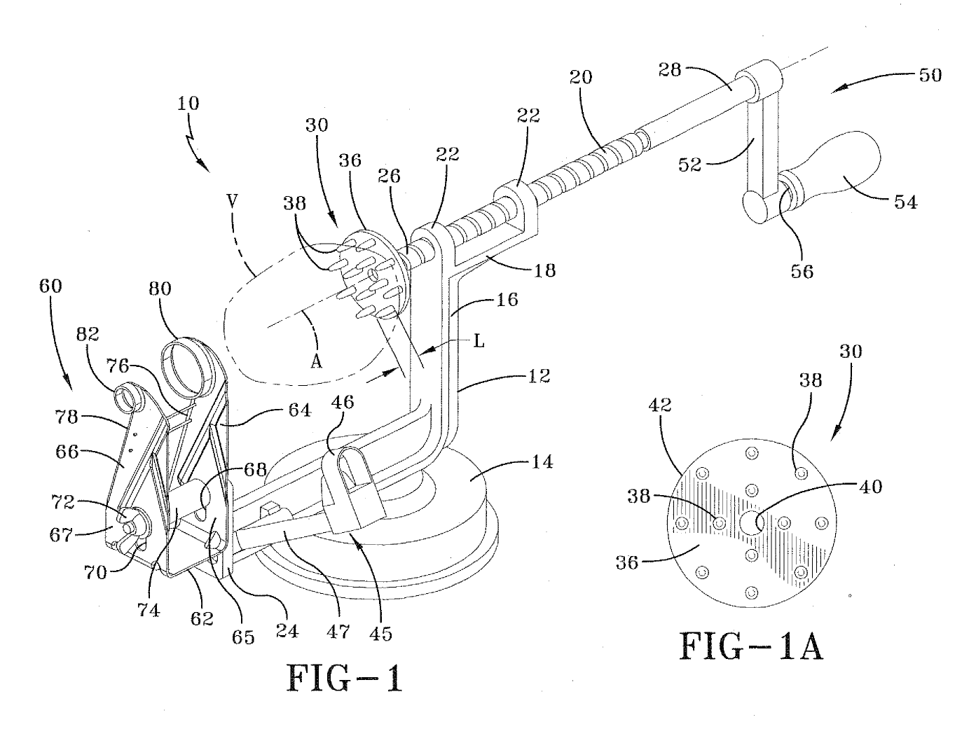

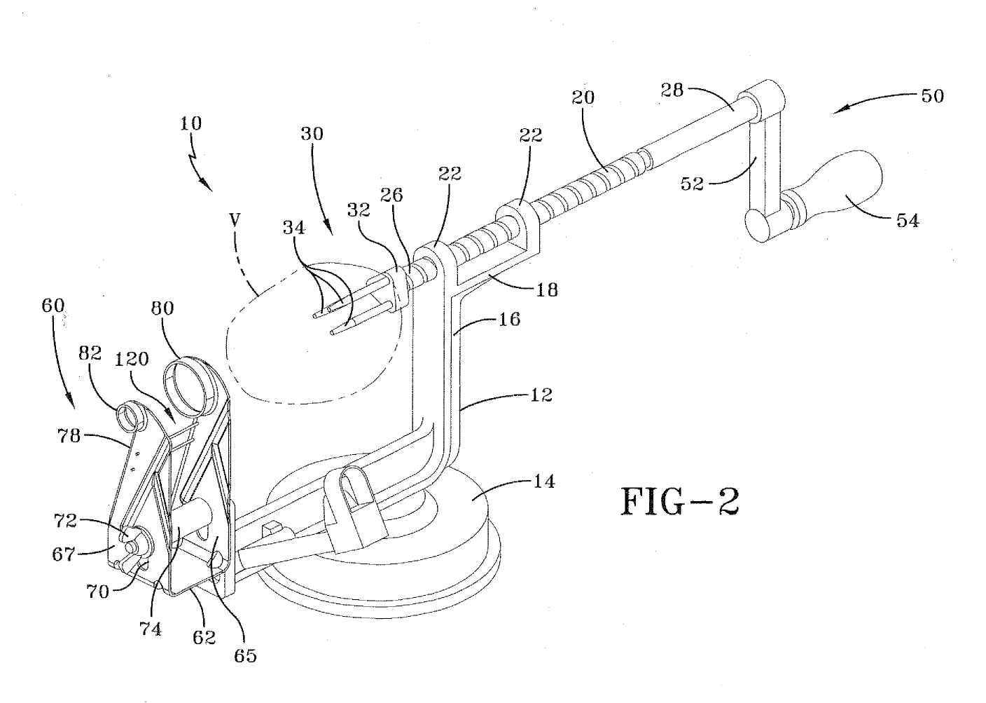

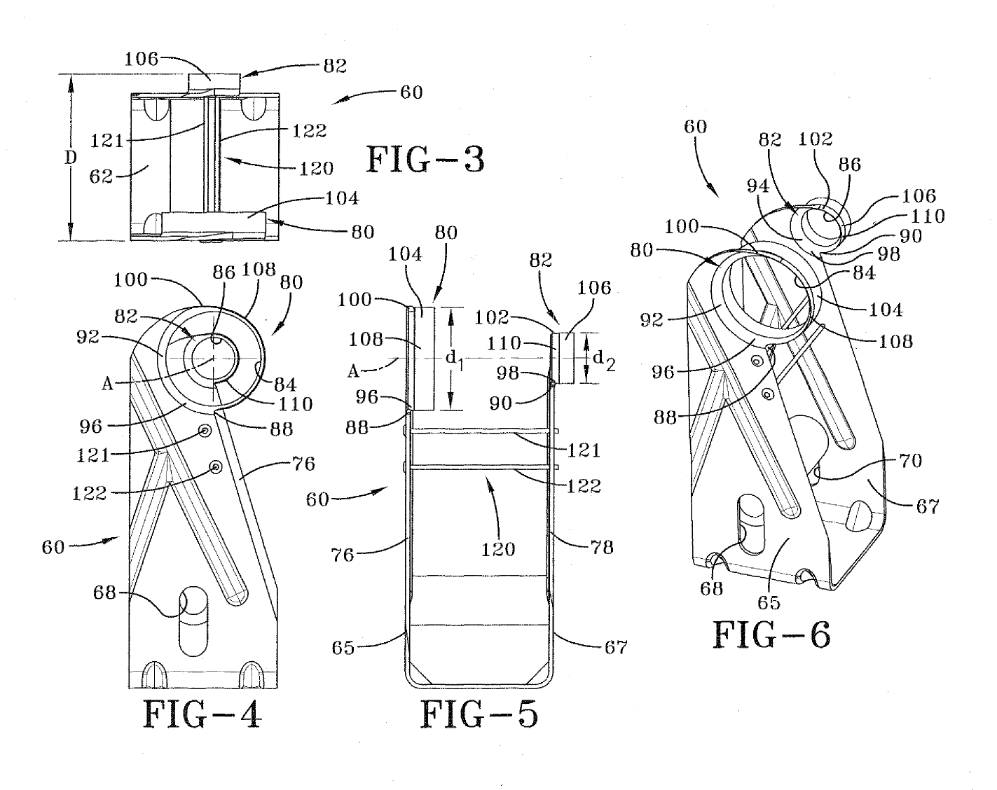

A holder, generally indicated by the number 30, may be supported on a first end 26 of shaft 20. Holder 30 may be any bracket or mounting surface that rotatably fixes the vegetable V so that is rotates with shaft 20. As shown in FIG. 2, holder 30 may include a head having a base 32 and three elongate tines or teeth 34. Alternatively, as shown in FIG. 1, holder 30 may include a circular plate 36 having plural short teeth 38 extending outward from its surface. It will be appreciated that while a triangular and circular base 32 are shown, base 32 may have any shape. Teeth 38 may be any projection that provide a gripping force that prevents holder 30 from slipping relative to vegetable V as shaft 20 is rotated. In the example shown, teeth 38 lie on a pair of concentric circles formed outward of the center bore 40 of plate 36. In the example shown in FIG. 1A, four teeth 38 lie on the first circle and are spaced 90 degrees from each other, and eight teeth 38 lie on an outer circle near the edge 42 of plate 36 and are spaced 45 degrees from each other. Teeth 38 are generally shorter than tines 34 in that they are not meant to penetrate deeply into vegetable V allowing a greater portion of vegetable V to be used before holder 30 reaches its stop. For example, teeth 34 having a length L measured from the outer surface of plate 36 of about 10 mm were found suitable.

A peeler generally indicated by the number 45 may be pivotally mounted inboard of blade support 24 to begin peeling vegetable V before vegetable V is cut. Peeler 45 may include a generally U-shaped blade 46 extending inwardly from an arm 47 that pivots about an axis that is parallel to the axis A of shaft 20. After vegetable V is mounted on holder 30, peeler 45 may be rotated inward from a disengaged position (shown) to an engaged position where blade 46 lies on the surface of vegetable V. As vegetable V is rotated, blade 46 of peeler 45 scrapes the skin off of vegetable V.

To rotate the vegetable V and drive it forward, a drive generally indicated by the number 50 may include a motor drive or a manual drive coupled to shaft 20. In the example shown, a manual drive is provided including a crank 52 extending downwardly from a second end 28 of shaft 20 and a handle 54 extending axially outward from the crank 52 and parallel to shaft 20. The handle 54 may be rotatably supported on a pin 56 extending from crank 52. It will be appreciated that manual drive may include any implement that facilitates rotation of shaft 20, including but not limited to a T-bar, pivoting handle, or knob coupled to shaft 20.

A cutting assembly generally indicated by the number 60 is supported on frame 12 opposite holder 30 and spaced therefrom to allow the vegetable V to be supported between the holder 30 and cutting assembly 60 during the peeling and cutting process. Cutting assembly 60 may include a base 62 having a first upright 64 and a second upright 66 extending upwardly therefrom and axially spaced from each other. First and second uprights 64, 66 may each have a generally rectangular lower portion 65, 67 that respectively define first and second receivers 68, 70 that receive a fastener 72 that secures the cutting assembly 60 to blade support plate 24. A tubular spacer 74 may extend between receivers 68, 70 to cover fastener 72 and provide additional support between uprights 64,66. As shown spacer 74 may have a smooth outer surface to facilitate cleaning and prevent the fastener from catching the peel formed by cutting assembly 10.

From lower portions 65, 67, uprights 64,66 continue to extend upwardly and may each include a cutting edge 76,78. Cutting edges 76,78 may be honed and may taper inward as they extend upward toward first and second annular blades 80,82. In the example shown, cutting edges 76,78 on uprights 64,66 extend inward from lower portions 65,67 and intersect the outer circumference of annular blades 80,82 near or at a plane extending through the center of annular blades 80,82.

First and second blades 80, 82 are axially spaced from each other a distance D. While generally any spacing may be used, it has been found that a spacing of greater of 25 mm facilitated the formation of the first peel and cutting the peel P into segments S before the second cutting operation begins at the second blade 82. A distance D greater than 39 mm was also found suitable. The distance D of the first and second blades shown in the figures is 39.6 mm. The distance D is measured from the leading edge of the first blade to the trailing edge of second blade.

First annular blade or first blade 80 has a first diameter d₁ and defines a first bore 84. Second annular blade or second blade 82 has a second diameter d₂ and defines a second bore 86. For example, first and second blades 80,82 may have a similar construction to create a spiral cut. First and second blades 80,82 each have a leading edge 88,90. From leading edge 88,90, each annular blade 80,82 extends in an arc and includes a inwardly beveled surface 92,94. Beveled surfaces 92, 94 each may trace a generally semi-circular arc from a lower portion 96,98 of each blade 80,82 to an upper portion 100,102 of each blade 80,82. In the example shown, beveled surfaces 92, 94 generally extend from a 6 o'clock position to a 12 o'clock position. The upper portions 100,102 of blades 80,82 taper inward in an axial outward direction to blend the beveled surfaces 92,94 into a ring portion 104,106. As shown, the exposed semi-circular edges 108,110 of ring portions 104,106 may be honed to form cutting surfaces for the respective first and second blades 80, 82. These cutting edges 108, 110 extend from a 12 o'clock to a 6 o'clock position in the example shown. The blade configurations shown are one example of annular blade and should not be considered limiting.

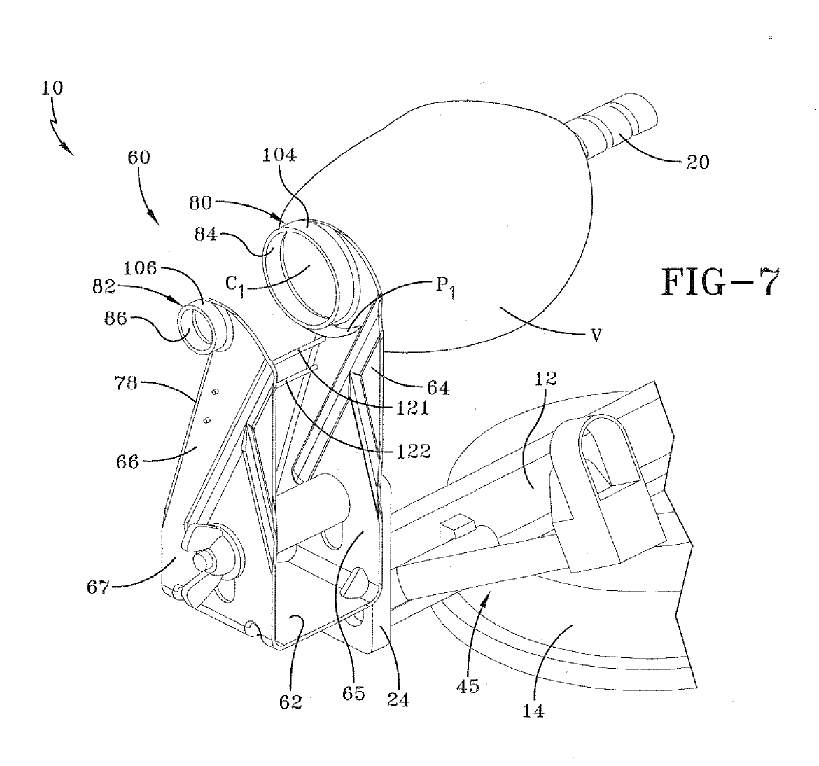

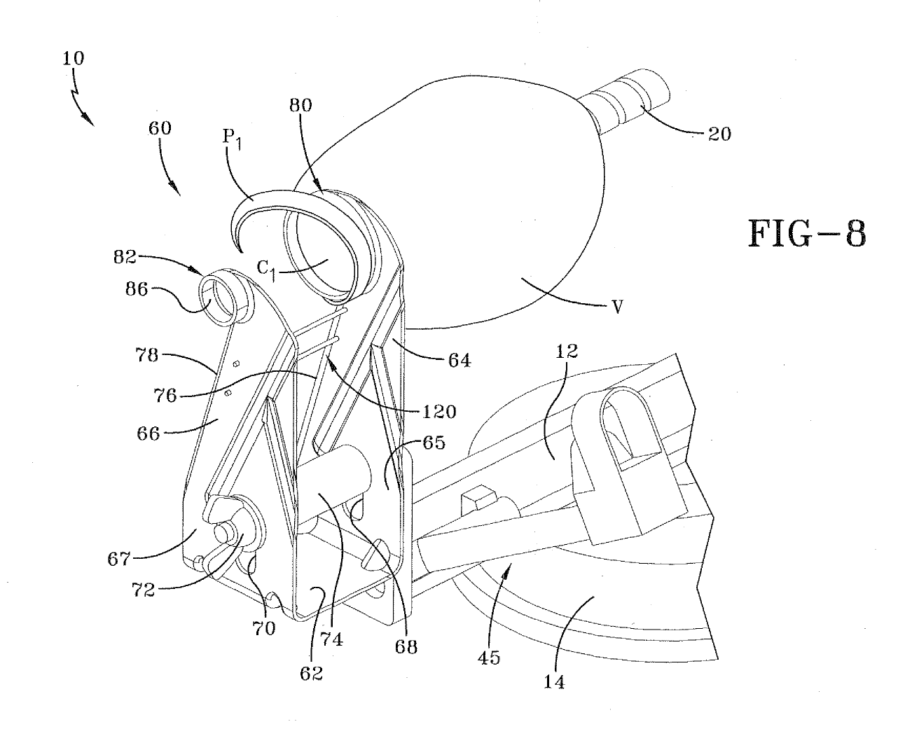

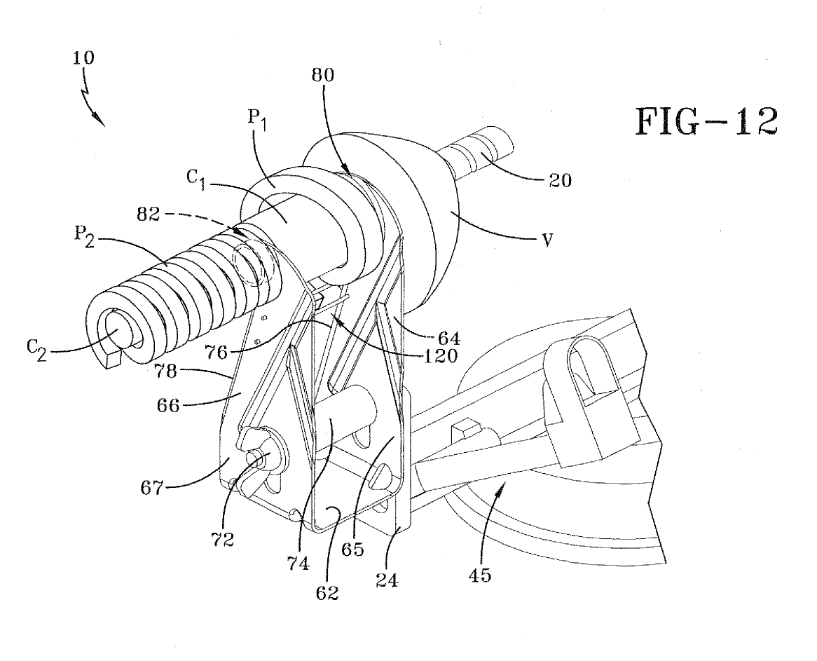

As best shown in FIGS. 4 and 5, first and second blades 80,82 may be aligned along a common axis. In the example shown, the centers of each blade 80,82 are aligned along the axis A of shaft 20. As a result, a core C₁ (FIG. 11) formed by the first cutting operation of first blade 80 is axially aligned with second blade 82 as it passes through the first bore 84. As shown in FIGS. 7 and 8, as vegetable V is rotated and driven axially to contact first blade 80, first blade 80 begins cutting a spiral first peel P₁ from vegetable V. First blade 80 continues to cut a first peel P₁ as vegetable V is rotated and driven past first blade 80.

Since it may be desirable to section the first peel P₁ into smaller spiral segments, one or more cross cutters, generally indicated by the number 120 may be provided after the first blade 80. Cross cutter 120 breaks the peel formed by first blade 80 into segments and thus avoids formation of wide peels that may be unsuitable for use as fries commonly formed by prior art cutters that only have a first blade. To improve upon the art by breaking the first peel P₁ into segments, a cutting assembly may be provided that has a first cutter and a cross cutter attached outward of the first blade. In the example, shown, cross cutter 120 extends outward relative to first blade 80 and is located between first and second blades 80,82. As best shown in FIG. 5, a pair of cross cutters may be used. A cross cutter 120 may be any surface capable of breaking or cutting the spiral cut peel P₁. In the example shown, first cutter and second cutter are pins 121,122 that extend transversely between uprights 64, 66. The pins 121, 122 are relatively thin and have a small diameter in relation to their length. It will be appreciated that blades or wires may be substituted in place of the pins to the same effect.

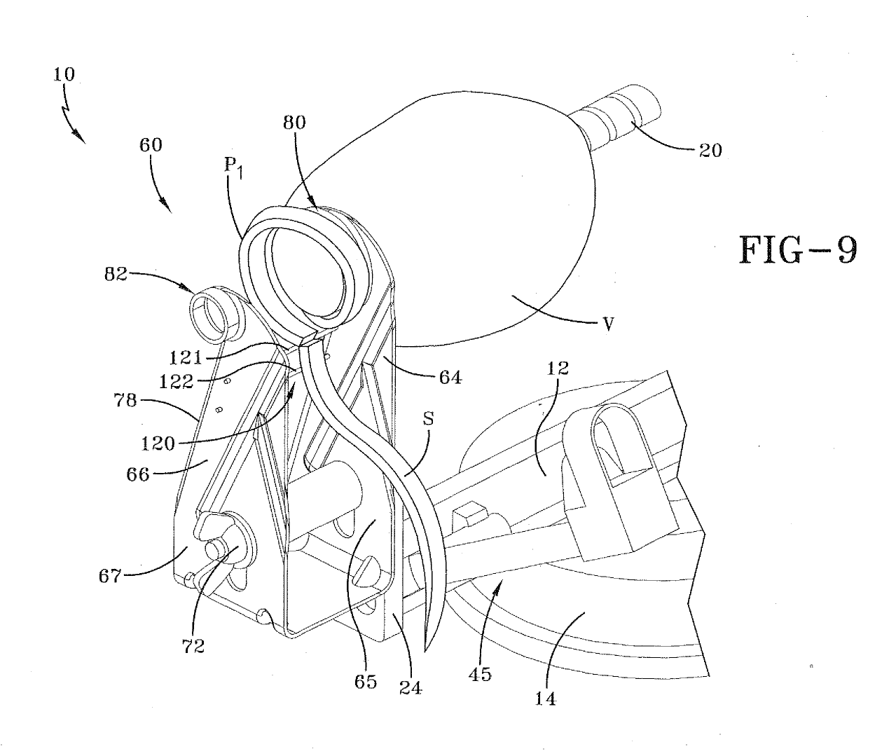

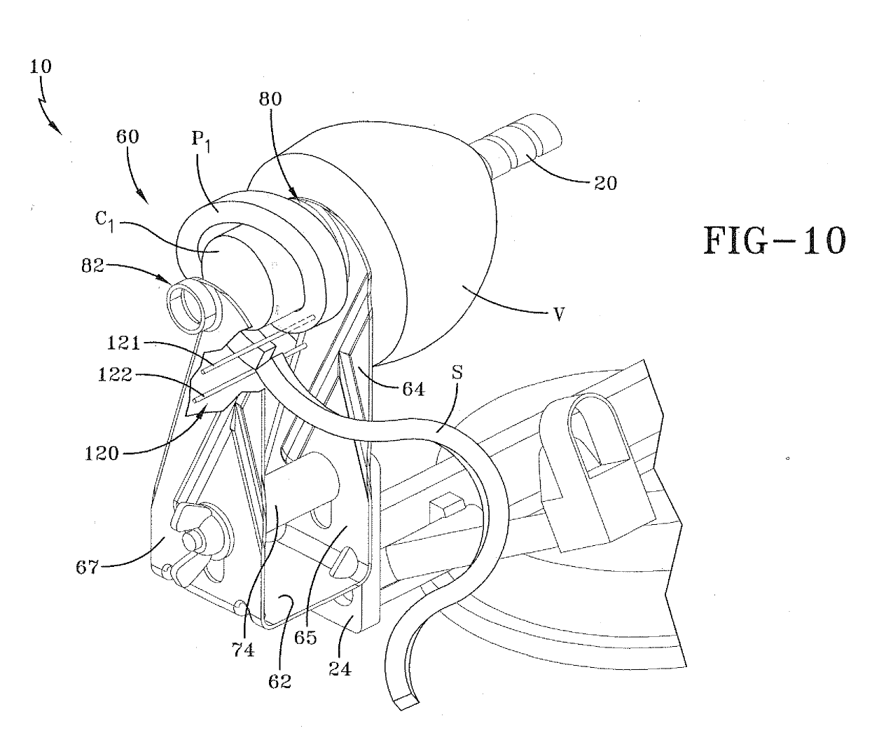

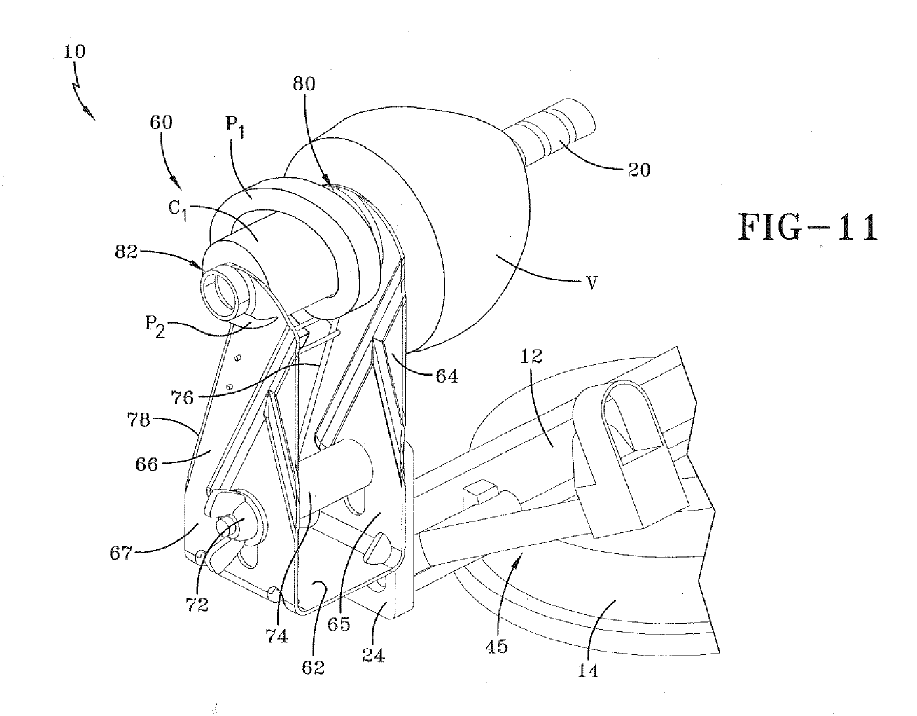

In general, cross cutter 120 is located below blades 80, 82. In the example shown, cross cutter 120 is located below the leading edge 88 of first blade 80. As best shown in FIGS. 4, 6 and 10, first and second pins 121, 122 may be arranged such that they are parallel to the edge of uprights 64, 66. In the example shown, pins 121, 122 are arranged parallel to each other and to axis A. This parallel arrangement relative to each other and the axis A, however, is not required and other arrangements may be used. As best shown in FIGS. 9 and 10, during operation of the cutter 10, the peel P₁ formed from vegetable V rotates as the shaft 20 is rotated and strikes cross cutter 120 causing the peel P₁ to break into one or more segments S. For example, as shown in FIG. 9, the peel P₁ may strike first end 121 depending on the orientation of the peel as it rotates. In other circumstances such as when the peel P₁ has drooped below second pin 122, the peel P₁ will strike the second pin 122 to form a segment S. (FIG. 10). It will be appreciated that the peel P₁ as a whole or individual segments S may be used as a curly fry.

As the shaft 20 continues to rotate and translate, the core C formed during the first cutting operation with the first blade 80 engages second blade 82. Second blade 82 has a smaller diameter d₂ than first blade 80 and defines a second bore 86 having a smaller diameter than first bore 84. The smaller diameter d₂ of blade 82 allows a second cutting operation to form an additional spiral cut peel P₂ from core C₁. As shown in FIGS. 11 and 12, because of the reduced diameter of second blade 82, the peel P₂ formed is generally smaller in cross section and has a tighter spiral.

Overall, the present invention improves upon the prior art by providing a cutting assembly having a first and second blade where the second blade has a smaller diameter than the first blade such that a second peel may be cut from the core that emerges from the first blade resulting in less waste. The present invention further improves upon the art by providing a cross-cutter that breaks the peel formed by the first blade into segments. By breaking the peel formed by the first blade into segments shortly after the first peel is formed wider peels that may not be suitable for use as fries are avoided. It will thus be seen that the vegetable cutter, according to the concepts of the present invention, that has been illustrated and described is a new and useful development in the art. It would be appreciated that various changes and modifications may be made to the embodiments described in the detailed description and depicted in the drawings without departing from the spirit of the invention. Therefore, for an appreciation of the scope of the invention, reference is made to the following claims.

What is claimed:

1. A cutter used to spirally slice a vegetable comprising:
a frame;
a shaft supported on said frame, said shaft defining an axis and being freely rotatable about said axis and movable along said axis;
a holder attached at one end of said shaft;
a cutting assembly supported opposite said holder having a first annular blade defining a first bore and a second annular blade defining a second bore, wherein said second annular blade is spaced axially outward from said first blade relative to said holder and wherein said second blade has a diameter smaller than a diameter of said first blade.

2. The cutter of claim 1 further comprising a cross cutter extending axially between said first and second blades.

3. The cutter of claim 2, wherein said cross cutter is located below said first and said second blades.

4. The cutter of claim 3, wherein said cross cutter includes a first pin and a second pin arranged parallel to each other and parallel to said axis of said shaft.

5. The cutter of claim 1, further comprising a drive adapted to rotate said shaft, wherein said shaft includes threads such that rotation of said shaft by said drive causes said shaft to advance said holder toward said cutting assembly.

6. The cutter of claim 1, wherein said cutting assembly includes a base having, a first upright and a second upright extending upwardly from said base, wherein said first blade is supported on said first upright and said second blade is supported on said second upright, wherein each upright includes a honed edge that extends upwardly and inwardly from said base toward said first and second blades.

7. The cutter of claim 1, wherein said holder includes a circular plate having plural teeth extending outwardly therefrom toward said cutting assembly.

8. The cutter of claim 7, wherein said teeth have a length less than 10 mm.

9. The cutter of claim 1, wherein said first blade and said second blade are axially spaced a distance greater than 25 mm.

10. The cutter of claim 9, wherein said distance is greater than 39 mm.

11. A cutting assembly used in connection with a peeler, the cutting assembly comprising:
a base having a first upright and a second upright extending upwardly from said base, said uprights being axially spaced from each other;
a first blade supported on said first upright adapted to form a first peel, said first blade having a first diameter; and
a second blade supported on said second upright, said second blade having a second diameter, wherein said second diameter is smaller than said first diameter.

12. The cutting assembly of claim 11, wherein said uprights include lower portions extending upwardly from said base, said lower portions defining a receiver adapted to receive a fastener for attaching the cutting assembly to the peeler.

13. The cutting assembly of claim 12, further comprising a cylindrical spacer extending between said uprights and aligned with said receivers in said uprights.

14. The cutting assembly of claim 11, wherein said uprights include cutting edges that taper inward from said lower section as they extend upward toward said first and second annular blades.

15. A cutting assembly used in connection with a peeler, the cutting assembly comprising:
a base having a first upright extending upwardly from said base;
a first blade supported on said first upright adapted to form a first peel; and
a cross cutter extending axially outward relative to said first blade and adapted to break the first peel formed by the first blade into a segment.

16. The cutting assembly of claim 15, further comprising a second upright extending upward from said base, said second upright being spaced axially outward from said first upright; and a second blade supported on said second upright, wherein said first blade and said second blade each have a diameter, wherein said second blade has a smaller diameter than said first blade, said first and second blades being aligned along a common axis.

17. The cutting assembly of claim 16, wherein said cross cutter comprises a pair of pins extending between said first and second uprights, said pins being located below said first blade.

18. A cutter for spirally cutting a vegetable, the cutter comprising:
a frame having a shaft support and a blade support;
a shaft supported on said frame;
said shaft defining an axis, said shaft being rotatable on said axis and said shaft being movable along said axis;
a holder mounted on said shaft and adapted to hold the vegetable such that it rotates with said shaft;
a manual drive coupled to said shaft;
a cutting assembly attached to said blade support, said cutting assembly including a first upright and a second upright axially spaced from each other, said first upright supporting a first blade and said second upright supporting a second blade, wherein said first and second blades respectively define a first bore having a first diameter and a second bore having a second diameter, wherein said second diameter is smaller than said first diameter;
said first and second blades being aligned on said axis;
a cross cutter comprising a pair of pins extending between said first and second uprights and located below said first blade.
